(19) United States
(12) Patent Application Publication
(10) Pub. No.: US 2024/0253278 A1
(43) Pub. Date: Aug. 1, 2024

(54) GROOVED ROLLER, DEVICE FOR EMBEDDING REINFORCEMENTS MADE OF STEEL IN A RUBBER MIXTURE WEB, AND USES OF THIS DEVICE

(71) Applicant: Continental Reifen Deutschland GmbH, Hannover (DE)

(72) Inventors: Daniel De Castro Pinho, Hohenhameln (DE); Pedro Neves, Baltar (PT); Richard Svitek, Wunstorf (DE); Frank Tautz, Garbsen (DE)

(73) Assignee: Continental Reifen Deutschland GmbH, Hannover (DE)

(21) Appl. No.: 18/560,637

(22) PCT Filed: Mar. 24, 2022
(86) PCT No.: PCT/DE2022/200056

§ 371 Date: Nov. 13, 2023

(30) Foreign Application Priority Data
May 20, 2021 (DE) 10 2021 205 119.7

(51) Int. Cl. B29C 43/46; B29C 43/24; B29C 43/28; B29D 30/38; B29K 21/00; B29K 305/12; B29L 30/00

(52) U.S. Cl. CPC B29C 43/46; B29C 43/24; B29C 43/28; B29D 30/38; B29C 2043/463; B29D 2030/381; B29K 2021/00; B29K 2305/12; B29L 2030/005

(57) ABSTRACT

A grooved roller having a multiplicity of guide grooves running parallel to one another and in encircling fashion over the circumference of said grooved roller and serve for guiding strength members of flattened cross section before they enter a roller calender, which strength members have, in cross section, a first diameter and, perpendicular thereto, a second diameter, the second diameter is smaller than the first diameter, and the two diameters are each determined at the points with the greatest widths. The guide grooves each have a U-shaped cross section with a groove base extending parallel to the roller axis and with two groove walls extending perpendicularly to the roller axis. The groove base has a width which at least corresponds to, and is up to 5% greater than, the first diameter of the strength member, and the groove walls have a height which is 50% to 90% of the second diameter of the strength member.

### CROSS-REFERENCE TO RELATED APPLICATIONS

The present application is a National Stage Application under 35 U.S.C. § 371 of International Patent Application No. PCT/DE2022/200056 filed on Mar. 24, 2022, which claims priority from German Patent Application No. 10 2021 205 119.7 filed on May 20, 2021, each of which is herein incorporated by reference in its entirety.

### TECHNICAL FIELD

The invention relates to a grooved roller having a multiplicity of guide grooves which run parallel to one another and in encircling fashion over the circumference of said grooved roller. The invention furthermore relates to a device for embedding strength members composed of steel into a rubber mixture web, and to uses of said device.

### BACKGROUND

It is general knowledge and routine to embed strength members, such as steel cords or monofilaments having a substantially circular cross section, into a rubber mixture web extending parallel to one another and in a plane by means of known devices. These devices usually comprise at least one creel having a multiplicity of strength members wound up on spools, aligning elements for aligning the strength members in parallel in a plane and at predefined distances from one another, and a grooved roller, which is mounted so as to be able to rotate about its roller axis and has guide grooves for the passage and for the transfer of the strength members into the press nip of a roller calender. The guide grooves have clear distances in relation to one another which correspond to the predefined clear distances between the strength members in the rubber mixture web. The reinforced webs, provided with embedded strength members, emerging from the roller calender are fed for further use, in particular in the production of pneumatic vehicle tires of any type, for example as belt plies or carcass inserts. The guide grooves of the known grooved rollers have an approximately V-shaped or trough-like cross section.

### SUMMARY

Reinforcing plies for pneumatic vehicle tires should particularly advantageously facilitate certain properties of the tires, ensure low weight of the tires and primarily help reduce the rolling resistance. In particular, high requirements are placed on strength members in belt plies of pneumatic vehicle tires; for example, and depending on the tire type, advantageous tensile strength and flexural rigidity, high fatigue resistance and high corrosion resistance. Furthermore, the reinforcing plies should facilitate a low tire weight, for instance contain as little rubber material as possible, that is to say have as thin as possible a design without adversely affecting the requirements placed on it. In this respect, now strength members having a flattened, non-circular cross-sectional shape are particularly advantageous, since they help to reduce the thickness of the reinforcing plies, this being associated with a reduction in the rubber material used and thus a decrease in the tire weight. In particular flattened steel cords, as are known for example from KR 10109719 B1, are therefore suitable for use in belt plies, in terms of the requirements placed on them. Advantageously, these steel cords should be embedded in a belt ply of a tire in such a way that they extend with their larger cross-sectional dimension parallel to the tire axis, or are embedded flat in the respective reinforcing ply. Conventional grooved rollers do not make it possible to bring about the desired orientation of strength members of flattened cross section.

The problem on which the invention is based is that of providing a grooved roller which allows embedding of steel strength members of flattened cross section such that said strength members run with their greatest width parallel or substantially parallel to the outer surfaces of the rubber mixture web.

The stated problem is solved according to the invention by means of a grooved roller having a multiplicity of guide grooves which run parallel to one another and in encircling fashion over the circumference of said grooved roller and which serve for guiding strength members of flattened cross section before they enter a roller calender, which strength members have, in cross section, a first diameter and, perpendicular thereto, a second diameter, wherein the second diameter is smaller than the first diameter, and the two diameters are each determined at the points with the greatest widths, wherein the guide grooves each have a U-shaped cross section with a groove base extending parallel to the roller axis and with two groove walls extending perpendicularly or substantially perpendicularly to the roller axis, wherein the groove base has a width which at least corresponds to, and is up to 5% greater than, the first diameter of the strength member, and wherein the groove walls have a height which amounts to 50% to 90% of the second diameter of the strength member.

It has surprisingly been found that a simple measure, that is to say the special geometry according to the invention of the guide grooves of the grooved rollers, has the effect that strength members of flattened cross section that are guided through the guide grooves automatically align themselves to lie flat in the guide grooves, with the result that they enter the press nip between the two rollers of the roller calender at least largely in the desired orientation.

In a preferred embodiment of the grooved roller, the width of the groove base of the guide grooves is up to 3% greater than the first diameter of the strength member. In a further, preferred embodiment of the grooved roller, the height of the groove walls of the guide grooves is at least 75% of the second diameter of the strength member. Guide grooves with this design in grooved rollers ensure a particularly reliable and precise alignment of the flattened strength members.

Also advantageous is an embodiment of the guide grooves in which the transitions between the groove walls and the groove base are rounded, in particular with a radius of at most 1.00 mm. The rounded corner regions at the base of the guide grooves counteract any tilting of the flattened strength members. For this reason, it is also advantageous if the groove walls of the guide grooves extend perpendicularly to the groove base or with a slight inclination in relation to the groove base, in particular at an angle of up to 3°. This inclination of the groove walls is outward, that is to say such that the guide grooves become slightly wider toward their upper opening.

In the case of a grooved roller according to the invention, it is also intended and advantageous for the guide grooves on the roller outer surface to have clear distances in relation to one another which correspond to the predefined clear distances between the strength members in the rubber mixture web.

The invention also relates to a device for embedding steel strength members into a rubber mixture web, wherein this device is provided with at least one creel having a multiplicity of strength members wound up on spools, with aligning elements for aligning the strength members in parallel in a plane at predefined distances from one another, and with a grooved roller, which is mounted so as to be able to rotate about its roller axis and is upstream of a roller calender, wherein the grooved roller is configured according to foregoing.

The invention furthermore relates to advantageous methods of using the device.

The use of this device for embedding steel cords of flattened cross section into a rubber mixture web is particularly preferred and advantageous. In particular, this involves embedding steel cords consisting of 2 to 11 steel filaments, in particular 3 to 9 steel filaments, particularly preferably 4 to 6, in particular exactly 5, steel filaments twisted together. The device according to the invention is therefore preferably used for embedding strength members into rubber mixture webs which are to have a particularly weight-reducing design and in so doing satisfy further requirements placed on them, for example in terms of tensile strength and flexural rigidity, fatigue resistance and corrosion resistance, particularly well.

Particularly advantageous in this respect is the use for embedding flattened steel cords comprising multiple flattened steel filaments having a larger diameter and, at right angles thereto, a smaller diameter, wherein the diameters are determined at the points with the greatest widths and the ratio of the smaller diameter to the larger diameter is 0.80, in particular 0.85 to 0.98. This provides strength member plies, reinforced with steel cords, that satisfy the stated requirements particularly well.

In an alternative use, linked to analogous advantageous effects, of the device, it is utilized to embed flattened steel monofilaments into a rubber mixture web.

If it is a case of creating reinforcing plies for pneumatic vehicle tires, it is advantageous if steel cords or steel monofilaments of which the ratio between the first diameter and the second diameter is 1.10 to 3.00, preferably 1.20 to 1.90, are embedded into a rubber mixture web.

According to the invention, the use of the rubber mixture web produced in a device according to the invention as belt ply in a belt assembly of a pneumatic vehicle tire, as carcass for a pneumatic vehicle tire, or as bead reinforcement ply for a pneumatic vehicle tire is therefore particularly advantageous.

### BRIEF DESCRIPTION OF THE DRAWINGS

Further features, advantages and details of the invention will now be described in more detail on the basis of the schematic drawing, which illustrates exemplary embodiments. In the drawing:

FIG. 1 shows a basic illustration of a device for producing a rubberized strength member ply comprising steel strength members for a pneumatic vehicle tire,

FIG. 2 shows a subregion of an axial longitudinal section through a grooved roller,

FIG. 3 shows an enlarged view of detail De from FIG. 2,

FIG. 4 shows a cross section through an exemplary embodiment of a steel cord, and

FIG. 5 shows a cross section through a subregion of a reinforcing ply of a pneumatic vehicle tire.

### DETAILED DESCRIPTION

Plies reinforced with steel strength members in pneumatic vehicle tires are in particular belt plies, carcass inserts or bead reinforcement plies in bead regions.

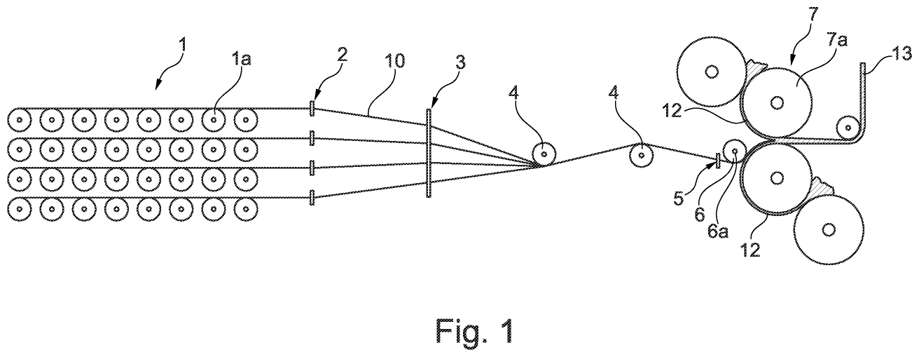

FIG. 1 shows essential constituent parts, following one another in the processing direction, of a device for providing strength members 10 with a rubber coating. In the exemplary embodiment shown, these constituent parts are at least one creel 1, aligning elements, including in particular perforated plates 2, sorting plates 3, guide rollers 4 and a separating comb 5, a grooved roller 6, which is mounted so as to be able to rotate about its roller axis 6a, and a roller calender 7. The creel 1 is provided with a multiplicity of spool holders and spools 1a, wound up on which are strength members 10 of matching configuration and design. The spool holders arranged on the creel 1 are each provided with a settable, for example electromagnetic, thread brake, in order to thus ensure the most optimum possible tensioning of the strength members 10 while they are being provided with the rubber coating.

The strength members 10 are either flattened steel cords, which in any desired design consist of 2 to 11 steel filaments, in particular 3 to 9 steel filaments, or flattened steel monofilaments. The steel cords and the steel monofilaments have an overall non-circular, flat cross section with a larger diameter D₁ (see D₁ in FIG. 4) and a diameter D₂ (see D₂ in FIG. 4), which is smaller than and at right angles to D₁. The diameters D₁ and D₂ are determined at the points with the greatest widths. The ratio of D₁ to D₂ is in particular 1.10 to 3.00, preferably 1.20 to 1.90. The steel filaments of the steel cord and the steel monofilaments in particular have a conventional tensile strength of 2500/mm² to 4500 N/mm², and the tensile strength is therefore substantially in the range from NT (Normal Tensile) to UT (Ultra Tensile).

FIG. 4 shows a schematic cross section through a flattened steel cord 8 comprising five steel filaments 9. The flattened steel cord 8 is produced in such a way that five steel filaments of identical design and circular cross section, with a diameter d of 0.10 mm to 0.60 mm, in particular 0.18 mm to 0.45 mm, are twisted together, resulting in steel cords which for the time being have a round, virtually circular cross section, in the form of “starting cords”. For example, these “starting cords” are deformed by a rolling operation, with the result that at least two steel filaments 9 in each case are locally flattened or deformed, in particular in the region of their points of mutual contact, and in the process at least to some extent are given an evenly or unevenly flattened cross-sectional shape (uneven cross-sectional shapes are not shown in the schematic FIG. 4), the steel cord 8 also being given a flattened cross section overall. By twisting the steel filaments 9, steel filaments 9, as viewed in different cross sections over the length of the steel cord 8, are deformed differently, and some might also not be deformed and then locally also have their original circular cross section, as shown in FIG. 4 with reference to the steel filament 9 that is at the outside on the left.

In the rolled, flattened cross-sectional shape of the steel cord 8, the steel filaments 9 flattened by deformation have a larger diameter d₁ transversely to the deformation direction and a smaller diameter d₂ at right angles thereto. The diameters d₁ and d₂ are also determined at the points with the greatest widths. In this case, the ratio of d₂ to d₁ is in particular 0.80 to 0.98, preferably 0.85 to 0.98. In the example shown of the steel cord 8, the ratio of D₁ to D₂ is also of the order of magnitude of 1.6.

Flattened steel monofilaments have, for example, an oval, elliptical or near-elliptical cross-sectional shape, their larger diameter is 0.10 mm to 1.50 mm, and their smaller diameter is 0.10 mm to 1.00 mm, the ratio of the larger diameter to the smaller diameter being 1.10 to 3.00, in particular 1.20 to 1.90. These diameters are also determined at the points with the greatest widths.

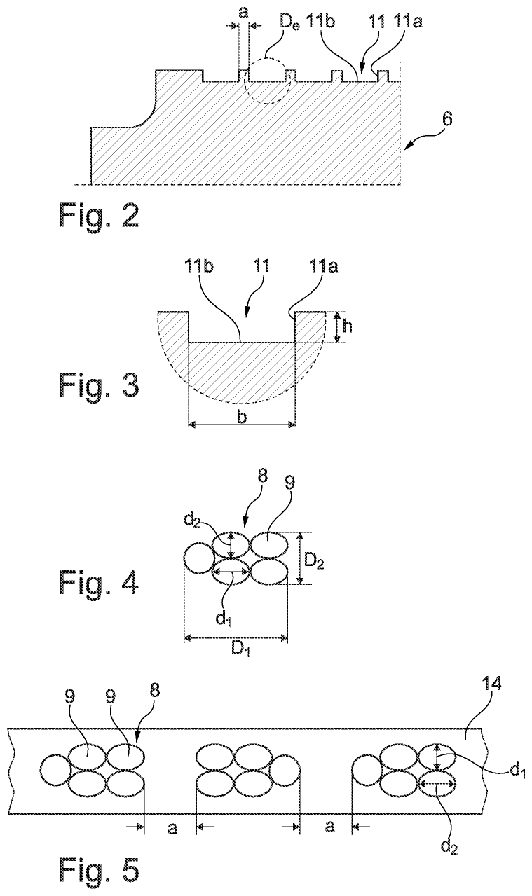

As shown in FIG. 1, the strength members 10—flattened steel cords or flattened steel monofilaments in an arbitrary orientation in relation to one another—unwound from the spools 1a of the creel 1 pass through holes in the perforated plates 2, then pass through the sorting plates 3 and are guided via multiple deflection rollers 4, in the process being aligned extending parallel to one another in a plane. The strength members 10 are then individually threaded through between lamellae of a separating comb 5 in a known way, with the desired distances between the strength members 10 being set in the separating comb 5. The set of strength members 10 then runs into guide grooves 11 of the grooved roller 6, each strength member 10 in one guide groove 11, with the clear distance a between the guide grooves 11 (FIG. 2) on the outer surface of the grooved roller 6 corresponding to the distance between the strength members 10 that is predefined by the thread separation at the separating comb 5. The guide grooves 11 extend over the circumference of the grooved roller 6 parallel to one another. The particular design of the guide grooves 11 will be explained in more detail below with reference to FIG. 3.

From the guide grooves 11 of the grooved roller 6, the set of strength members 10 runs into the press nip between two calender rollers 7a of the roller calender 7. A calendered rubber mixture 12 is also fed to the press nip both from above and from below, with the result that the strength members 10 are embedded in the rubber mixture with mutually parallel extents. The rubber mixture web 13 with thusly embedded strength members 10 leaves the press nip and is fed for further use in tire construction.

In order that all the strength members 10 can be embedded lying flat, that is to say with their larger dimension, the diameter D₁, extending as parallel as possible to the outer surfaces of the rubber mixture web 13, the guide grooves 11 have a particular U-shaped cross section. Each guide groove 11 is formed by two groove walls 11a, extending perpendicularly to the roller axis 6a, and a groove base 11b, extending parallel to the roller axis 6a. The width b of the groove base 11b is matched to the diameter D₁ of the respective strength member 10 in that the width b of the groove base 11b at least corresponds to, and is up to 5%, in particular up to 3%, greater than, the diameter D₁. The height h of the groove walls 11a is matched to the diameter D₂ of the respective strength member 10, the height h corresponding to 50% to 90%, preferably up to 75%, of the diameter D₂. The transitions between the groove walls 11b and the groove base 11a are preferably rounded with a radius of at most 1.0 mm. The flattened strength members 10, which enter the guide grooves 9 in an arbitrary orientation and under low tension, align themselves flat automatically in the guide grooves 9 owing to the geometry of the guide grooves 11, and therefore they enter the press nip between the two rollers 7a of the roller calender 7 at least largely in the aforementioned orientation.

FIG. 5 shows a cross section through a portion of a reinforcing ply 14, for example an unprocessed belt ply, for a pneumatic vehicle tire with embedded steel cords 8 according to FIG. 4. The clear distance a between the steel cords 8 corresponds to the clear distance a between mutually adjacent guide grooves 11 of the grooved roller 6.

Strength members 10 embedded in this way make it possible primarily to considerably decrease the thickness of reinforcing plies in pneumatic vehicle tires in relation to comparable strength members of circular cross section and thus advantageously reduce the weight of the tire.

### LIST OF REFERENCE SIGNS

1 . . . Creel
1a . . . Spool
2 . . . Perforated plate
3 . . . Sorting plate
4 . . . Guide roller
5 . . . Separating comb
6 . . . Grooved roller
7 . . . Roller calender
7a . . . Calender roller
8 . . . Steel cord
9 . . . Steel filament
10 . . . Strength member
11 . . . Guide groove
11a . . . Groove wall
11b . . . Groove base
12 . . . Rubber mixture
13 . . . Rubber mixture web
14 . . . Reinforcing ply
b . . . Width of the groove base
h . . . Height of the groove wall
D₁, D₂ . . . Diameter
d₁, d₂ . . . Diameter

1. A grooved roller having a multiplicity of guide grooves which run parallel to one another and in encircling fashion over the circumference of said grooved roller and which serve for guiding reinforcements of flattened cross section before they enter a roller calender, which the reinforcements have, in cross section, a first diameter and, perpendicular thereto, a second diameter, wherein the second diameter is smaller than the first diameter, and the first and second diameters diameters are each determined at the points with the greatest widths,
wherein the guide grooves
each have a U-shaped cross section with a groove base extending parallel to the roller axis and with two groove walls extending perpendicularly or substantially perpendicularly to the roller axis, wherein the groove base has a width which at least corresponds to, and is up to 5% greater than, the first diameter, and wherein the groove walls have a height which is 50% to 90% of the second diameter.

2. The grooved roller as claimed in claim 1, wherein the width of the groove base is up to 3% greater than the first diameter of the strength member.

3. The grooved roller as claimed in claim 1, wherein the height of the groove walls is at least 75% of the second diameter.

4. The grooved roller as claimed in claim 1, wherein the transitions between the groove walls and the groove base are rounded, with a radius of at most 1.0 mm.

5. The grooved roller as claimed in claim 1, wherein the groove walls of the guide grooves extend substantially perpendicularly to the roller axis in that the groove walls extend with an outward inclination at an angle of up to 3° in relation to the groove base.

6. The grooved roller as claimed in claim 1, wherein the guide grooves on the roller outer surface have clear distances in relation to one another which correspond to the predefined clear distances between the reinforcements in the rubber mixture web.

7. A device for embedding reinforcements into a rubber mixture web, comprising at least one creel having a multiplicity of the reinforcements wound up on spools, comprising aligners configured to align the reinforcements in parallel in a plane at predefined distances from one another, and comprising a grooved roller, which is mounted so as to be able to rotate about its roller axis, and is downstream of the aligners and is upstream of a roller calender, wherein the reinforcements have a flattened cross section before they enter the roller calender, which the reinforcements have, in cross section, a first diameter and, perpendicular thereto, a second diameter, wherein the second diameter is smaller than the first diameter, and the first and second diameters are each determined at the points with the greatest widths, wherein the guide grooves of the grooved roller each have a U-shaped cross section with a groove base extending parallel to the roller axis and with two groove walls extending perpendicularly or substantially perpendicularly to the roller axis, wherein the groove base has a width which at least corresponds to, and is up to 5% greater than, the first diameter, and wherein the groove walls have a height which is 50% to 90% of the second diameter.

8. The device as claimed in claim 7 wherein the reinforcements are in the form of steel cords.

9. The device in claim 8 wherein the steel cords which consist of 2 to 11 steel filaments.

10. The device in claim 9 wherein the steel cords consist of 4 to 6 steel filaments twisted together.

11. The device in claim 9 wherein the steel cords consist of 5 intertwined steel filaments.

12. (canceled)

13. The device in claim 7 in which a ratio of the smaller diameter to the larger diameter is 0.80 to 0.98.

14. The device in claim 7, wherein the width of the groove base is up to 3% greater than the first diameter, and wherein the height of the groove walls is at least 75% of the second diameter.

15. The device in claim 7, configured such that the reinforcements run from the guide grooves of the grooved roller into a press-on gap between two calender rolls of the roller-calender, and the device being configured such that a calendered rubber mixture is also fed to the press-on gap both from above and from below, so that the reinforcements are parallel to one another when embedded in the rubber mixture to form the rubber mixture web.

16. The device in claim 7, wherein the aligners include one or more of:
perforated plates having holes through which the multiplicity of reinforcements are fed from the spools,
sorting plates through which the multiplicity of reinforcements are fed,
deflection rollers over which the multiplicity of reinforcements are fed,
a dividing comb having slats through which the multiplicity of reinforcements are fed.

17. A method forming a rubber mixture web using the device according to claim 8, comprising:
feeding the reinforcements from the spools through the aligners that align the reinforcements in parallel in a plane at predefined distances from one another,
feeding the reinforcements from the aligners to the guide grooves of the grooved roller;
feeding the reinforcements from the guide grooves of the grooved roller into a press-on gap between calender rolls of the roller-calender,
feeding a calendered rubber mixture to the press-on gap both from above and from below,
embedding the reinforcements in the rubber mixture so that the reinforcements are parallel to one another when embedded in the rubber mixture to form the rubber mixture web.

18. A method of forming a pneumatic tire, comprising:
forming the rubber mixture web according to the method of claim 17,
using the rubber mixture web as a belt layer of the pneumatic tire.
